(19) United States
(12) Patent Application Publication
(10) Pub. No.: US 2026/0134155 A1
(43) Pub. Date: May 14, 2026

(54) ARTIFICIAL INTELLIGENCE SUPPLY CHAIN INTEGRITY AND PROVENANCE SYSTEM

(71) Applicant: George William Bickerstaff, III, Greenwich, CT (US)

(72) Inventor: George William Bickerstaff, III, Greenwich, CT (US)

(21) Appl. No.: 19/444,110

(22) Filed: Jan. 8, 2026

(51) Int. Cl. G06F 21/64; G06F 21/60

(52) U.S. Cl. CPC G06F 21/64; G06F 21/602

(57) ABSTRACT

An artificial intelligence supply chain integrity and provenance system is disclosed that records origin and lineage of supply chain components, verifies integrity during execution, intercepts compromised operations, and generates cryptographically verifiable certification artifacts. The system enables continuous trust, containment, and recovery across artificial intelligence lifecycles.

### TECHNICAL FIELD

The present invention relates to artificial intelligence systems and, more particularly, to technical systems and methods for verifying integrity, provenance, and authenticity across artificial intelligence supply chains, including data assets, model artifacts, execution environments, and inference operations.

### BACKGROUND

Artificial intelligence systems increasingly rely on complex supply chains composed of training data sources, preprocessing pipelines, model artifacts, execution environments, and downstream inference workflows. These supply chains often span organizational boundaries, infrastructure providers, and deployment environments, increasing the risk of unauthorized modification, corruption, or substitution of critical components.

Existing approaches to artificial intelligence governance and security focus primarily on perimeter controls, access management, or static audits. Such approaches are insufficient to ensure integrity in dynamic environments where models and data are updated, redeployed, and executed continuously.

Unauthorized modification of supply chain components may propagate through downstream systems, resulting in incorrect outputs, security exposure, or regulatory non-compliance.

Accordingly, there exists a need for a technical system that verifies provenance, detects integrity deviations at execution time, prevents propagation of compromised components, and produces machine-verifiable certification artifacts across the artificial intelligence lifecycle.

### SUMMARY OF THE INVENTION

The invention provides an artificial intelligence supply chain integrity and provenance system configured to record origin and lineage of artificial intelligence supply chain components, establish machine-executable integrity baselines, and perform execution-time verification of data, models, and inference behavior.

The system intercepts execution when integrity deviations are detected, prevents completion of compromised operations, initiates containment and recovery actions, and generates cryptographically verifiable certification artifacts. By embedding integrity enforcement directly into execution pathways, the invention improves system reliability, reduces propagation of compromised components, and enables continuous, automated trust across artificial intelligence supply chains.

### DEFINITIONS

### Certification Artifact

A cryptographically verifiable data structure attesting to integrity, provenance, and validated operational state of one or more artificial intelligence supply chain components.

### Execution Environment

A hardware and/or software context in which an artificial intelligence model is trained, deployed, or executed.

### Inference Path

A sequence of computational operations executed to produce an inference output.

### Integrity Baseline

A machine-executable representation of expected integrity characteristics associated with a supply chain component.

### Integrity Event

A detected deviation between observed execution behavior and an expected integrity baseline.

### Model Provenance

Structured metadata describing origin, version lineage, and historical relationships of an artificial intelligence model.

### Provenance Ledger

A cryptographically protected, append-only data store used to record provenance records and integrity events.

### Supply Chain Component

Any data asset, model artifact, execution environment element, or system module contributing to artificial intelligence operation.

### Tamper Detection Signal

A machine-detectable indicator generated upon detection of an integrity event.

### Version Lineage

A chronological linkage of successive versions of a supply chain component enabling traceability and rollback.

### BRIEF DESCRIPTION OF THE DRAWINGS

FIG. 1 illustrates model provenance tracking.

FIG. 2 illustrates training data lineage verification.

FIG. 3 illustrates execution-time inference path validation.

FIG. 4 illustrates integrity event detection and response.

FIG. 5 illustrates certification and audit artifact generation.

### DETAILED DESCRIPTION OF THE INVENTION

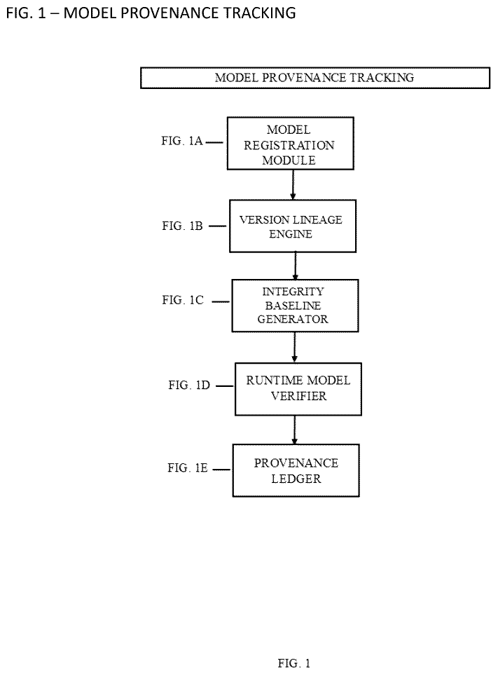

### FIG. 1—Model Provenance Tracking

Models are registered prior to deployment with associated provenance metadata and version lineage. Integrity baselines are generated and stored in the provenance ledger. Registered models are linked to prior versions to enable traceability and rollback.

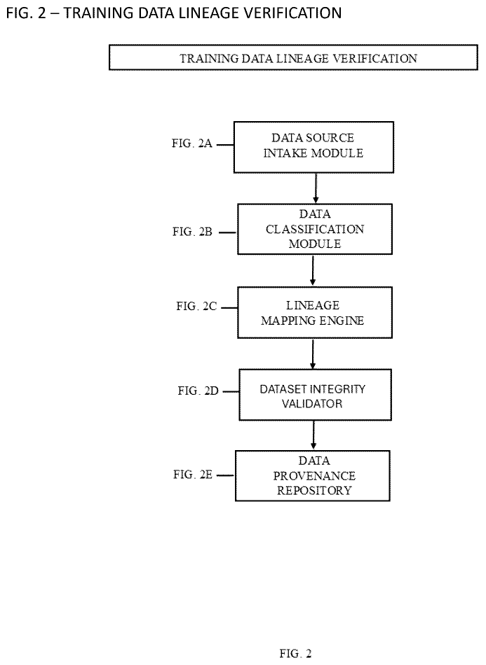

### FIG. 2—Training Data Lineage Verification

Training datasets are ingested with associated provenance records capturing source identifiers and transformation history. Dataset integrity is validated before and after training operations, and lineage records are retained in the provenance ledger.

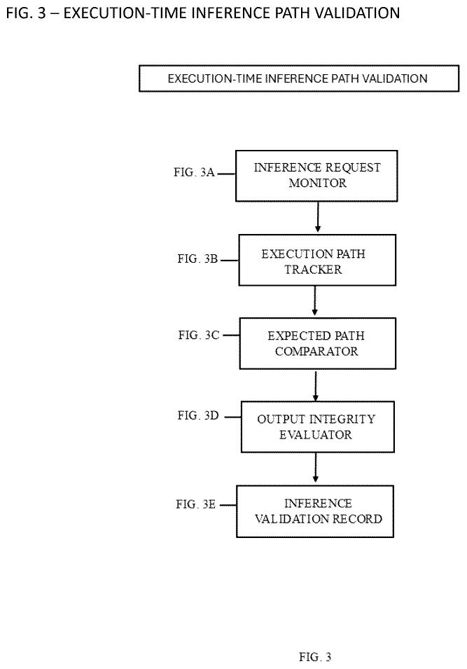

### FIG. 3—Execution-Time Inference Path Validation

Inference requests are monitored during runtime. Execution paths are tracked and compared against expected inference paths derived from stored integrity baselines. Deviations are detected prior to inference completion.

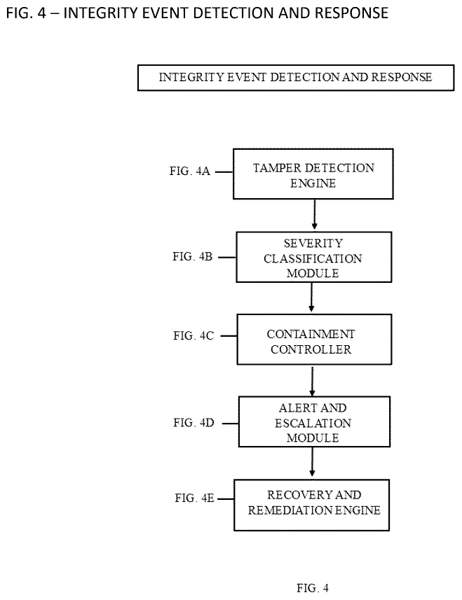

### FIG. 4—Integrity Event Detection and Response

Detected deviations generate tamper detection signals indicative of integrity events. Compromised supply chain components are isolated, execution is halted or rerouted, and recovery operations are initiated using verified prior versions.

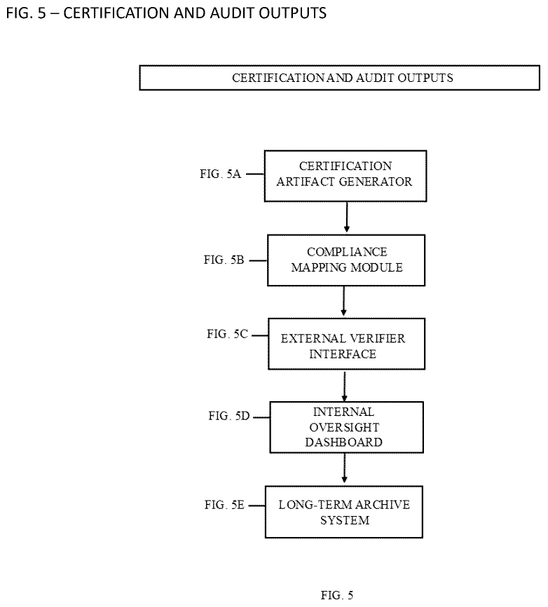

### FIG. 5—Certification and Audit Outputs

Following validation or recovery, certification artifacts are generated attesting to integrity and provenance. Artifacts and associated logs are archived for audit and downstream verification.

### Illustrative Operational Example (Non-Limiting)

In one illustrative, non-limiting example, an artificial intelligence system is deployed using the supply chain integrity and provenance system described herein. Prior to deployment, multiple training datasets are ingested by a data intake module, and corresponding provenance records are generated capturing source identifiers, transformation history, and version lineage. Cryptographic integrity baselines for the datasets are computed and stored in an append-only, tamper-evident provenance ledger.

An artificial intelligence model is trained using the registered datasets and is registered with a model registration module. During registration, model provenance metadata and version lineage information are captured, and a machine-executable integrity baseline is generated for the trained model. The integrity baseline is stored and associated with the registered model for subsequent runtime verification.

The trained model is deployed into an execution environment where inference requests are received during runtime operation. As an inference request is processed, an execution interception layer monitors the inference path and compares observed execution behavior against the stored integrity baseline. During execution, a deviation is detected between the observed inference path and an expected inference path, resulting in generation of a tamper detection signal indicative of an integrity event.

In response to the integrity event, the execution interception layer halts completion of the inference and prevents further execution using the affected model instance. A containment controller isolates the compromised supply chain component and initiates a recovery operation. Using stored version lineage information, a verified prior version of the model is restored and revalidated against its integrity baseline before being returned to service.

Following successful recovery, a certification artifact generator produces a cryptographically verifiable certification artifact attesting to the integrity, provenance, and validated operational state of the artificial intelligence system. The certification artifact, along with associated provenance records and integrity event logs, is archived in the provenance ledger and made available for audit, verification, or downstream system validation.

This example demonstrates execution-time interception, integrity verification, containment, recovery, and certification without limiting the scope of the claimed invention.

1. An artificial intelligence supply chain integrity system, comprising:
a provenance tracking module configured to record origin and version lineage of artificial intelligence supply chain components;
an integrity baseline generator configured to produce machine-executable integrity baselines; and
an execution interception layer configured to monitor execution and prevent completion of an operation when an integrity event is detected.

2. A method for verifying integrity of an artificial intelligence system, comprising:
recording provenance records associated with supply chain components;
establishing integrity baselines;
monitoring execution behavior during runtime; and
intercepting execution in response to detected integrity deviations.

3. A non-transitory computer-readable medium storing instructions that, when executed, cause a system to verify integrity of artificial intelligence supply chain components and generate certification artifacts.

4. The system of claim 1, wherein provenance records are stored in a cryptographically protected, append-only ledger.

5. The system of claim 1, wherein execution interception occurs prior to inference completion.

6. The method of claim 2, further comprising isolating a compromised component upon detection of an integrity event.

7. The method of claim 2, further comprising restoring a verified prior version using stored version lineage.

8. The system of claim 1, wherein certification artifacts are cryptographically verifiable.

9. The computer-readable medium of claim 3, wherein integrity events are logged for audit.

10. The system of claim 1, wherein integrity verification occurs continuously during runtime.
